(19) United States
(12) Patent Application Publication
(10) Pub. No.: US 2009/0223296 A1
(43) Pub. Date: Sep. 10, 2009

(54) ATTACHMENT STRUCTURE FOR ULTRASONIC SENSOR

(75) Inventors: Yoshihisa Sato, Nagoya-city (JP); Yasuhiro Kawashima, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/399,582

(22) Filed: Mar. 6, 2009

(30) Foreign Application Priority Data
Mar. 7, 2008 (JP) 2008-58422

(51) Int. Cl. G01N 29/00; A47B 96/06

(52) U.S. Cl. 73/632; 248/224.7

(57) ABSTRACT

Disclosed is an ultrasonic sensor attachment structure which provides coincidence between a center of the ultrasonic-sensor and that of a through-hole in a simple way, and which restricts unwanted-vibration-transmission between a wall-member of a movable-body and an ultrasonic-transducer without spoiling design. According to the structure, the sensor, which includes the ultrasonic-transducer, a case receiving the ultrasonic-transducer and a vibration-insulation-member for vibration-transmission-suppression, is attached to the wall-member having the through-hole, so that an oscillation-surface is exposed to an outer-surface side through the through-hole. The ultrasonic-sensor is fixed by a fixation-member so that the oscillation-surface and an outer-surface of the wall-member are on a substantially same plane. The fixation-member includes a positioning-member, which provides substantial coincidence between a center of the oscillation-surface of the ultrasonic-sensor and that of the through-hole, and which is made of a material suppressible of vibration-transmission between the ultrasonic-transducer and the wall-member.

### CROSS REFERENCE TO RELATED APPLICATION

The present application is based on Japanese Patent Application No. 2008-58422 filed on Mar. 7, 2008, the disclosure of which is incorporated herein by reference.

### BACKGROUND OF THE INVENTION

1. Field of the Invention

The present invention relates to an attachment structure for attaching an ultrasonic sensor to a wall member of a movable body such as a vehicle bumper having a through-hole.

2. Description of Related Art

There has been proposed such an attachment structure for an ultrasonic sensor that a module (e.g., ultrasonic sensor) is fixed to a retain part (e.g., fixation member) attached to an inside (e.g., inner surface) of a bumper having a through-hole so that an end surface (e.g., an oscillation surface) of a head part of the ultrasonic sensor and an outer surface of the bumper are on the same plane. For instance, Patent Document 1 shows such attachment structures.

In a case of the above structure, the oscillation surface of the ultrasonic sensor is exposed to an outside through the through-hole of the bumper, and it is preferable in respects of design that a clearance between a wall surface defining the through-hole and the ultrasonic sensor is approximately constant in entire wall surface circumference. According to a structure shown in Patent Document 1, in order for the clearance to be constant in the entire wall surface circumference, it is however required to insert a centering member (e.g., cylindrical member) having an outer shape corresponding to a shape of the through-hole in the through-hole, and in this insertion state, it is required to attach a fixation member to a part of the inner surface of the bumper around the through-hole with reference to the centering member, and then to fix the ultrasonic sensor to the fixation member. Patent Document 2 proposes a fixation member for fixing a body (e.g., ultrasonic sensor) to an inside of a wall member (e.g., inner surface of the wall ember), the fixation member including a collar for positioning the fixation member relative to a hole (e.g., through-hole).

[Patent Document 1] JP-P2001-502406A corresponding to U.S. Pat. No. 6,279,210

[Patent Document 2] JP-P2001-527480A corresponding to U.S. Pat. No. 6,318,774

According to Patent Document 2, however, the collar is rigidly provided in the fixation member. Thus, when this fixation member is used for attaching an ultrasonic sensor having an ultrasonic transducer for both transmission and reception and a case receiving the ultrasonic transducer, there arises a problem that reverberant or echo remains longer and a nearby obstacle is difficult to be detected, if a member for restricting unwanted vibration transmission is not disposed between the ultrasonic transducer and the collar.

Further, if the member for restricting the unwanted vibration transmission is disposed between the ultrasonic transducer and the collar, the collar and the member for suppressing the unwanted vibration are disposed between the wall surface defining the through-hole and the ultrasonic transducer. Accordingly, a size of the through-hole enlarges and design becomes worse.

### SUMMARY OF THE INVENTION

In view of the above points, it is an objective of the present invention to provide an attachment structure which provides coincidence between a center of an ultrasonic sensor and a center of a through-hole in a simple way, and which restricts unwanted vibration transmission between a wall member of a movable body and an ultrasonic transducer without spoiling design.

According to a first aspect of the present invention, an attachment structure including an ultrasonic sensor, a wall member equipped in a movable body, and a fixation member is provided. The ultrasonic sensor includes: an ultrasonic transducer having an oscillation surface for ultrasonic wave transmission and reception; a case receiving the ultrasonic transducer with the oscillation surface being exposed from the case; and an vibration insulation member disposed between the case and the ultrasonic transducer to suppress unwanted vibration transmission between the ultrasonic transducer and the case. The wall member has a through-hole with an opening shape corresponding to a shape of the oscillation surface. The fixation attaches the ultrasonic sensor to the wall member so that the oscillation surface is exposed to an outer surface side through the through-hole. The case of the ultrasonic sensor receives the ultrasonic transducer from a rear surface opposite to the oscillation surface to a part of a portion of a side surface, the side surface being other than the rear surface and the oscillation surface, the portion of the side surface is located on an inner surface side, wherein the fixation member is disposed on an inner surface of the wall member and disposed around the through-hole, wherein the case is fixed by the fixation member so that the oscillation surface and the outer surface of the wall member are on a substantially same plane. The fixation member includes a positioning member, wherein the positioning member is inserted into the through-hole, and contacts one of a wall surface defining the through-hole and an inner surface side corner part connecting to the wall surface, and the portion of the side surface of the ultrasonic transducer, the portion of the side surface being exposed from the case, wherein the positioning member cause a center of the through-hole to match a center of the oscillation surface of the ultrasonic sensor, which is fixed to the fixation member. The positioning member is made of a material suppressible of vibration transmission between the ultrasonic transducer and the wall member.

According to the above attachment structure, it is possible to match the center of the ultrasonic sensor and the center of the through-hole and to restrict unwanted vibration transmission between the wall member of the movable body and the ultrasonic transducer without spoiling design.

According to a second aspect of the present invention, an attachment structure for use in a vehicle is provided that includes an ultrasonic sensor and a fixation member. The ultrasonic sensor includes: an ultrasonic transducer having an oscillation surface for ultrasonic wave transmission and reception; a case receiving a part of the ultrasonic transducer with the oscillation surface being exposed from the case; and an vibration insulation member disposed between the case and the ultrasonic transducer to suppress vibration transmission between the case and the ultrasonic transducer. The fixation member attaches the ultrasonic sensor to a wall member of the vehicle, wherein the wall member has: an outer surface exposed to an outside of the vehicle; an inner surface opposite to the outer surface; and a through-hole penetrating between the outer and inner surfaces with an opening shape corresponding to a shape of the oscillation surface. The fixation member is disposed on the inner surface of the wall member and disposed around the through-hole. The fixation member attaches the ultrasonic sensor to the wall member so that the oscillation surface is exposed to the outside of the vehicle through the trough-hole. The ultrasonic sensor further has a rear surface opposite to the oscillation surface, and a side surface located between the oscillation surface and the rear surface. The case receives the part of the ultrasonic transducer from the rear surface of the ultrasonic transducer so that a part of the side surface of the ultrasonic transducer is exposed from the case. The fixation member includes: a retainer that fixes the case so that the oscillation surface and the outer surface of the wall member are on a substantially same plane, and so that the exposed part of the side surface of the ultrasonic transducer is located in the through-hole and located closer the outer surface of the wall member than the inner surface; and a positioning member that is inserted into the through-hole, contacts the exposed part of the side surface of the ultrasonic transducer, further contacts at least of an inner wall surface side corner part and a wall surface defining the through-hole of the wall member, and positions the ultrasonic transducer at a place where a center of the oscillation surface substantially matches a center of through-hole, the inner surface side corner part which connects the wall surface of the through-hole and the inner surface of the wall member. The positing member is made of a material suppressible of vibration transmission between the ultrasonic transducer and the wall member.

According to the above attachment structure, it is possible to match the center of the ultrasonic sensor and the center of the through-hole and to restrict unwanted vibration transmission between the wall member of the movable body and the ultrasonic transducer without spoiling design.

According to a third aspect of the present invention, there is provided an attachment structure for use in attaching an ultrasonic sensor to a wall member of a vehicle. The ultrasonic sensor includes: an ultrasonic transducer having an oscillation surface for ultrasonic wave transmission and reception, and a rear surface opposite to the oscillation surface; a case receiving a part of the ultrasonic transducer from the rear surface of the ultrasonic transducer so that a part of a side surface located between the oscillation surface and the rear surface is exposed from the case; and an vibration insulation member disposed between the case and the ultrasonic transducer to suppress vibration transmission between the case and the ultrasonic transducer. The wall member has: an outer surface exposed to an outside of the vehicle; an inner surface opposite to the outer surface; and a through-hole penetrating between the outer and inner surfaces with an opening shape corresponding to the oscillation surface. The attachment structure includes a fixation member that is disposed on the inner surface of the wall member and disposed around the through-hole, and that attaches the ultrasonic sensor to the wall member so that the oscillation surface is exposed to the outside of the vehicle through the trough-hole. The fixation member includes: a retainer that fixes the case so that the oscillation surface and the outer surface of the wall member are on a substantially same plane, and so that the exposed part of the side surface of the ultrasonic transducer is located in the through-hole and located closer the outer surface of the wall member than the inner surface; and a positioning member that is inserted into the through-hole, contacts the exposed part of the side surface of the ultrasonic transducer, further contacts at least one of an inner wall surface side corner part and a wall surface defining the through-hole of the wall member, and positions the ultrasonic transducer at a place where a center of the oscillation surface substantially matches a center of through-hole, the inner surface side corner part which connects the wall surface of the through-hole and the inner surface of the wall member. The positing member is made of a material suppressible of vibration transmission between the ultrasonic transducer and the wall member.

According to the above attachment structure, it is possible to match the center of the ultrasonic sensor and the center of the through-hole and to restrict unwanted vibration transmission between the wall member of the movable body and the ultrasonic transducer without spoiling design.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross sectional diagram illustrating an attachment structure for an ultrasonic sensor according to a first embodiment;

FIG. 2 is a plan view corresponding to FIG. 1, the view being taken from an outside of a vehicle;

FIG. 3 is a cross sectional diagram illustrating an attachment structure for an ultrasonic sensor according to a modification example; and

FIG. 4 is a cross sectional diagram illustrating a positioning member according to another modification example.

### DETAILED DESCRIPTION OF THE EXEMPLARY EMBODIMENTS

Exemplary embodiments are described below with reference to the accompany drawings. An attachment structure for use in a vehicle is presented below as an exemplary attachment structure for use in a movable body.

### First Embodiment

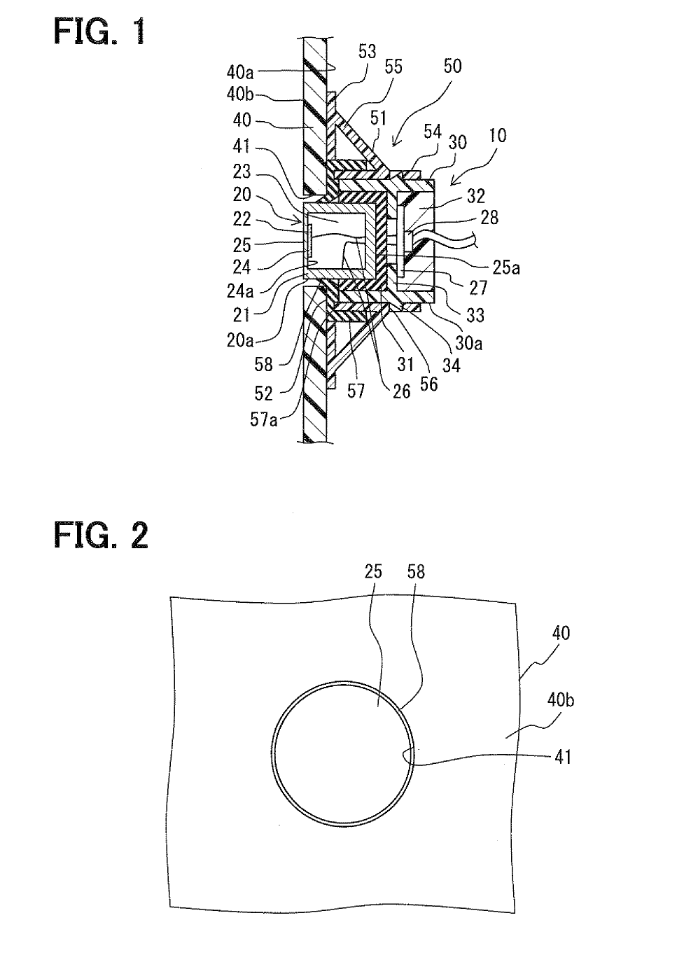

FIG. 1 is a cross sectional diagram illustrating an attachment structure for an ultrasonic sensor in accordance with a first embodiment. FIG. 2 is a plan view corresponding to FIG. 1, the view being taken from an outside of a vehicle. A direction in which a through-hole extends is refereed to hereinafter as a penetration direction, and a direction perpendicular to the penetration direction is referred to hereinafter as a perpendicular direction.

The ultrasonic sensor is attached to a front part of a vehicle, a rear part of the vehicle, or four-cornered parts of a bumper so that the ultrasonic sensor can detect an obstacle existing around the vehicle. As shown in FIG. 1, the ultrasonic sensor 10 includes: an ultrasonic transducer 20 (e.g., so called a microphone) for both of transmission and reception; a case 30 receiving the ultrasonic transducer 20 so that an oscillation surface 25 of the ultrasonic transducer 20 is exposed; and a vibration insulation member 31 disposed between the case and the ultrasonic transducer 20.

The ultrasonic transducer 20 includes a piezoelectric element 22 and a housing 21 receiving therein the piezoelectric element 22. The housing 21 is made of a conductive material such as aluminum etc. and formed in a tubular shape having a closed end. Alternatively, the housing 21 may be made of resin and has a metal coated inner surface. The housing 21 defines therein an internal space 23, as shown in FIG. 1. The piezoelectric element 22 is bonded to an inner surface 24a of a bottom part 24 of the housing 21. Accordingly, an outer surface of the bottom part 24 (which is opposite to the inner surface 24a) can function as an oscillation surface of the ultrasonic transducer 20. The oscillation surface has a generally circular shape, as shown in FIG. 2.

The piezoelectric element 22 includes a sintered piezoelectric ceramic, such as lead zirconate titanate (PZT), barium titanat and the like. Electrodes (not shown) are respectively formed on a surface, which is a bonding surface between the piezoelectric element 22 and the housing, and its opposite surface. On end of a lead 26 is connected with the electrode located on the surface opposite to the boding surface and the electrode located on the bonding surface. Another end of the lead 26 sticks out from the housing 21. Accordingly, it is possible apply an alternating current to ends of the piezoelectric element 22 through the lead 26 to drive the piezoelectric element 22 by the application of the alternating current drives. It is accordingly possible to oscillate the oscillation surface of the ultrasonic transducer 20. After the lead 26 is connected (e.g., soldered), the internal space 23 of the housing 21 is filled with a vibration absorption member (not shown) so that the vibration absorption member surrounds the piezoelectric element 22 except a surface facing the bottom part 24. The vibration absorption member is made of an elastic material such as silicon, polyurethane and the like, and restricts vibration due to the piezoelectric element 22 from transmitting to parts other than the bottom part 24 of the housing 21.

Together with a circuit board 27, the ultrasonic transducer 20 having the above-described configuration is installed in a case 30 made of an insulation material, e.g., resin.

The circuit board 27 is electrically connected to the piezoelectric element 22 via the lead 26. The circuit board 27 includes a circuit for outputting a drive signal to the piezoelectric element 22 to oscillate and generate an ultrasonic wave, and for receiving a voltage signal generated due to an inverse piezoelectric effect when the piezoelectric element 22 has strains resulting from transmission of the ultrasonic wave to the piezoelectric element 22. Further, the circuit board 27 is connected to a controller (not shown) via a connector 28. The controller detects an obstacle existing rearward of a vehicle or around the corner parts.

The vibration insulation member 31 is interposed inside the case 30 to suppress unwanted vibration transmission between the ultrasonic transducer and the case 30. In the present embodiments, the vibration insulation member 31 is made of silicon rubber and disposed in a periphery of the ultrasonic transducer 20. To seal an inside of the case 30, rear of the circuit board 27 is filled with a sealing member 32 made of, for example, silicon rubber. The periphery of the ultrasonic transducer 20 includes, for example, a part of a side surface 20a of the ultrasonic transducer 20 and a rear surface 25a of the ultrasonic transducer 20 opposite to the oscillation surface 25.

The case 30 receives a part of the side surface 20a of the ultrasonic transducer 20 from the rear surface 25a opposite to the oscillation surface 25, so that the part of the side surface 20a becomes located closer to the inner surface 40a of the bumper 40 than the outer surface, the bumper 40 being an example of the wall member. In the present embodiments, the case 30 is formed in a cylindrical shape, a middle of an inside of which a stopper 33 is formed. The stopper 33 can fix the ultrasonic transducer 20 which is applied by the vibration insulation member 31 and which is inserted from one open end. The stopper 33 can fix the circuit board 27 which is inserted from another open end. When the ultrasonic transducer 20 applied by the vibration insulation member 31 is installed in the case 30, the open end of the case 30 located on a bumper 40 side becomes concentric with the oscillation surface 25 of the ultrasonic transducer 20. In the present embodiments, an end part of the vibration insulation member 31 located on the bumper 40 side is also concentric with the open end of the case 30 located on the bumper 40 side and the shape of the oscillation surface 25 of the ultrasonic transducer 20.

As shown in FIG. 2, the ultrasonic sensor 10 having the above-described configuration is fixed to the bumper 40 by the use of the fixation member 50 with a part of the ultrasonic sensor 10 being located inside the through-hole 41, so that sensing is possible through the through-hole 41, or in other words, ultrasonic transmission and reception is possible without involving the bumper 40, wherein the through-hole 41 of the bumper 40 has a circular opening shape corresponding to the shape of the oscillation surface 25. In the above fixed state, the oscillation surface 25 of the ultrasonic transducer 20 and the outer surface 40b of the bumper 40 are on the same plane. As shown in FIG. 1, the fixation member 50 contacts both of the case 30 of the ultrasonic sensor 10 and the inner surface 40a of the bumper 40. The fixation member 50 includes a retainer 51 for fixing the ultrasonic sensor 10 to the bumper 40 and a positioning member 52 for positioning the retainer 51 relative to the bumper 40 with reference to the through-hole 41.

The retainer 51 positions the ultrasonic sensor 10 in the penetration direction of the through-hole 41, and maintains this positioning state. In the present embodiments, the retainer 51 is made of polybutylene terephthalate resin (PBT), and includes a bumper fixation portion 53, a sensor fixation portion 54 and a connection portion 55. The bumper fixation portion 53 has a plate shape, and is adhesively fixed to the inner surface 40a of the bumper 40. The sensor fixation portion 54 has a cylindrical shape surrounding an outer periphery surface 30a of the case 30 so as to receive and support the case 30 of the ultrasonic sensor 10 therein. Further, at least a part of the sensor fixation portion 54 contacts the outer periphery surface 30a, thereby forming a fixation structure between the part of the sensor fixation portion and the case 30. The connection portion 55 connects the bumper fixation portion 53 and the sensor fixation portion 54. More specifically, a fitting connection concave part 56 is disposed on the sensor fixation portion 54, and a fitting connection convex part 34 for fitting into the fitting connection concave part 56 is disposed on the outer periphery surface 30a of the case 30. With the bumper fixation portion 53 being fixed to the inner surface 40a of the bumper 40, the ultrasonic sensor 10 is inserted into the inside of the tubular-shaped sensor fixation portion 54 while the oscillation surface 25 is being a lead of the insertion until the fitting connection convex part 34 fits into the fitting connection concave part 56, and thereby, the oscillation surface 25 and the outer surface 40b are on the same plane.

The positioning member 52 positions the retainer 51 relative to the bumper 40 with reference to the through-hole 41, as described above. Thereby, in the perpendicular direction, the positioning member 5 functions to generally match the center of the through-hole 41 and the oscillation surface 25 of the ultrasonic sensor 10 fixed to the retainer 51. The positioning member 52 is made of a material different from that of the retainer 51, more specifically made of a material such as silicon rubber etc., which is capable of suppressing unwanted vibration transmission between the ultrasonic transducer 20 and the bumper 40. Accordingly, the positioning member 52 can function as an absorber that suppresses the unwanted vibration transmission between the ultrasonic transducer 20 and the bumper 40.

In the present embodiments, the positioning member 52 includes a retainer fixation portion 57 to be fixed to the retainer 51 and an insertion portion 58 to be inserted into the through-hole 41. The retainer fixation portion 57 is fixed to the retainer 51. The insertion portion 58 is inserted into the through-hole 41, contacts a exposed part of a side surface 20a of the ultrasonic transducer 20 that is exposed from the case 30, and further contacts one of the wall surface defining the through-hole 41 and an inner surface side corner part (a corner part between the wall surface and the inner surface 40a) connecting to the wall surface.

The retainer fixation portion 57 has a ring shape so as to surround the side surface 20a of the ultrasonic transducer 20. Its sectional shape has a generally L shape, and includes: a part that contacts a part of an outer periphery surface of the sensor fixation portion 54 of the retainer 51; and a part that contacts the inner surface 40a of the bumper 40. A ditch part 57a is formed in the part that contacts the inner surface 40a of the bumper 40, and the ditch part 57a fits into a bumper side end part of the sensor fixation portion 54. Thereby, the retainer 51 and the positioning member 52 are integrated as the fixation member 50. The insertion portion 58 is extended toward a through-hole side tip of the part of the retainer fixation member 57, the part which contacts the inner surface 40a of the bumper 40.

The insertion portion 58 includes a part of the positioning member 52, wherein the part is located (radially) inward of the wall surface defining the through-hole 41 in the perpendicular direction, and the part surrounds the side surface 20a of the ultrasonic transducer 20 in a manner similar to the retainer fixation portion 57. Compared to the part connecting the retainer fixation portion 57, the part contacting the side surface 20a of the ultrasonic transducer 20 is located closer the outer surface 40b of the bumper 40. As closer to the outer surface 40b of the bumper 40, an opening area defined by the ring-shaped insertion portion 58 becomes smaller. The insertion portion 58 is located closer to the inner surface 40a of the bumper 40 than the outer surface 40b of the bumper 40 while an end part of the insertion portion 58 located on the outer surface 40b side does not project from the outer surface 40b of the bumper 40. Further, the insertion portion 58 contacts the corner part (which is an inner surface side corner part connecting with the wall surface defining the through-hole 41) defined between the wall surface of the through-hole 41 and the inner surface 40a of the bumper 40.

Further, the ring-shaped insertion portion 58 contacts the exposed part of the ultrasonic transducer in an entire side surface circumference, the exposed part being exposed from the case 30 (vibration insulation member 31). More specifically, a perpendicular direction length (a thickness in a radial direction of the through-hole 41), which is from a wall surface side end of the through-hole to the part that contacts the side surface 20a of the ultrasonic transducer 20, is generally constant in the entire circumference.

In the present embodiments, since the inner surface side corner part is used as a reference for the positioning as described above, the part of the insertion portion 58 contacting the side surface 20a of the ultrasonic transducer 20 is located closer to the outer surface 40b of the bumper 40 compared to the part of the insertion portion 58 connecting the retainer fixation portion 57, and further, the insertion portion 58 contacts the exposed part of the side surface 20a of the ultrasonic transducer 20 in the through-hole 41, wherein the exposed part of the side surface 20a of the ultrasonic transducer 20 is exposed from the case 30. Further, an inner periphery surface of the ring-shaped insertion portion 58 has a tapered part which is located in a predetermined range starting from an end distant from the outer surface 40b and which approaches the side surface 20a of the ultrasonic transducer 20 as closer to the outer surface 40b in the penetration direction.

In the followings, explanation is given on advantages of the above-described attachment structure for the ultrasonic sensor 10.

First of all, in the present embodiments, the fixation member 50 for fixing the ultrasonic sensor 10 to the bumper 40 includes: the retainer 51 which is fitted into the ultrasonic sensor 10 and determine a position of the ultrasonic sensor 10 relative to the bumper 40 in the penetration direction; and the positioning member 52 which determines the position of the ultrasonic sensor 10 relative to the bumper 40 in the perpendicular direction. This positioning member 52 includes: a retainer fixation portion 57 which is to be fixed to the retainer 51; and the insertion portion 58 which has a ring shape, is to be inserted into the through-hole 41 and is to contact the inner surface side corner part of the bumper 40 in the entire circumference. Accordingly, the positioning of the fixation member 50 relative to the bumper 40 is possible in attaching the fixation member 50 to the bumper 40, by inserting the insertion portion 58 into the through-hole 41 and making contact between the insertion portion 58 and the inner surface side corner part of the bumper 40 in the entire circumference. In other words, it is possible determines a position (e.g., x-y coordinates) on a plane extending along the inner surface 40a of the bumper. Further, the positioning of the fixation member 50 relative to the bumper 40 in the penetration direction is possible by making contact between the bumper fixation portion 53 of the retainer 51 and the inner surface 40a of the bumper 40. In other words, it is possible determines a position (e.g., z-coordinate) in a direction perpendicular to the inner surface 40a of the bumper 40. Further, it is possible to maintain the positioned state in such manner that the bumper fixation portion 53 is adhered to the inner surface 40a of the bumper 40 with the positioning in the perpendicular and penetration directions being made. Since the ultrasonic sensor 10 can be fixed to the fixation member 50 fixed in the above manner, it is possible to provide an attachment structure where the center of the oscillation surface 25 matches the center of the through-hole 41 in the perpendicular direction. As described above, according to the present embodiments, in fixing the fixation member 50 to the bumper 40, it is possible to determine the position of the fixation member 50 with reference to the bumper 40 by using the fixation member itself. Therefore, the centering member is not necessary, and the center of the ultrasonic sensor 10 (the oscillation surface 25) and that of the through-hole can match each other in a simple way. Further, according to the present embodiments, the positioning member 52 is made of a material (e.g., silicon rubber) capable of suppressing unwanted vibration transmission between the ultrasonic transducer 20 and the bumper 40. Therefore, while the positioning member 52 contacts both of the ultrasonic transducer 20 and the bumper 40, the positioning member 52 can suppress unwanted vibration transmission between both.

Further, as described above, the positioning member 52 of the fixation member 50 has a perpendicular direction positioning function and a function of suppression of unwanted vibration transmission between the ultrasonic transducer 20 and the bumper 40. Thus, since the positioning member 52 contacts both of the ultrasonic transducer 20 and the bumper 40, and thus, a clearance between the side surface 20a (the oscillation surface 25) of the ultrasonic transducer 20 and the through-hole wall surface (open end) of the bumper 40 may be ensured to a thickness of the positioning member 52 (the insertion portion 58) or the like. Therefore, it is possible to reduce a radial size (opening area) of the through-hole 41 compared to a structure where a member having a positioning function (positioning member) and a member for suppressing an un-wanted wave transmission are laminated, or compared to a structure where a positioning member does not contact the side surface 20a of the ultrasonic transducer 20 (a structure where there exist a gap to the positioning member in the perpendicular direction). Accordingly, it is possible to suppress design aggravation.

Further, according to the present embodiments, the shape of the oscillation surface 25 (a shape defined by side surface of the ultrasonic transducer 20) is the same of the opening shape of the through-hole 41 (the through-hole 41 is larger in dimensions). Because of the above-described advantages associated with the positioning, as shown in FIG. 2, the clearance (the above-described clearance) between the oscillation surface 25 and the open end of the bumper 40 can be approximately constant in the entire circumference. It is accordingly possible to provide design improvement.

Further, according to the present embodiments, the insertion portion 58 has a ring shape and contacts the side surface 20a of the ultrasonic transducer 20 in the entire circumference. Thus, as shown in FIG. 2, when the bumper 40 is viewed from an outer surface 40b side, the clearance between the oscillation surface 25 and the bumper 40 does not have a clearance (gap) in the perpendicular direction (a space located on the outer surface 40b of the bumper 40 and a space located on the inner surface 40a side are interrupted by the insertion portion 58). Accordingly, design improvement is also made possible. Further, according to the present embodiments, the positioning member 52 (the insertion portion 58) does not project from the outer surface 40b of the bumper although the positioning member 52 is inserted in the through-hole 41. It is accordingly possible to provide design improvement.

Further, according to the present embodiments, the inner periphery surface of the insertion portion 58 has a tapered part which is located in the predetermined range starting from the end distant from the outer surface 40b and which approaches the side surface 20a of the ultrasonic transducer 20 as closer to the outer surface b in the penetration direction. Thus, when the part of the ultrasonic transducer 20 of the ultrasonic sensor 10 is inserted into the through-hole 41 from the inner surface 40a side while the oscillation surface 25 is a lead of the insertion, the taper can guide the ultrasonic transducer 20 to a predetermined position, and thereby, it is possible to ease the insertion.

While the present invention is described above with reference to the exemplary embodiments, the present invention is not limited to the above-described embodiments. The present invention can be modified in various ways for embodiments to an extent without departing from the scope of the present invention.

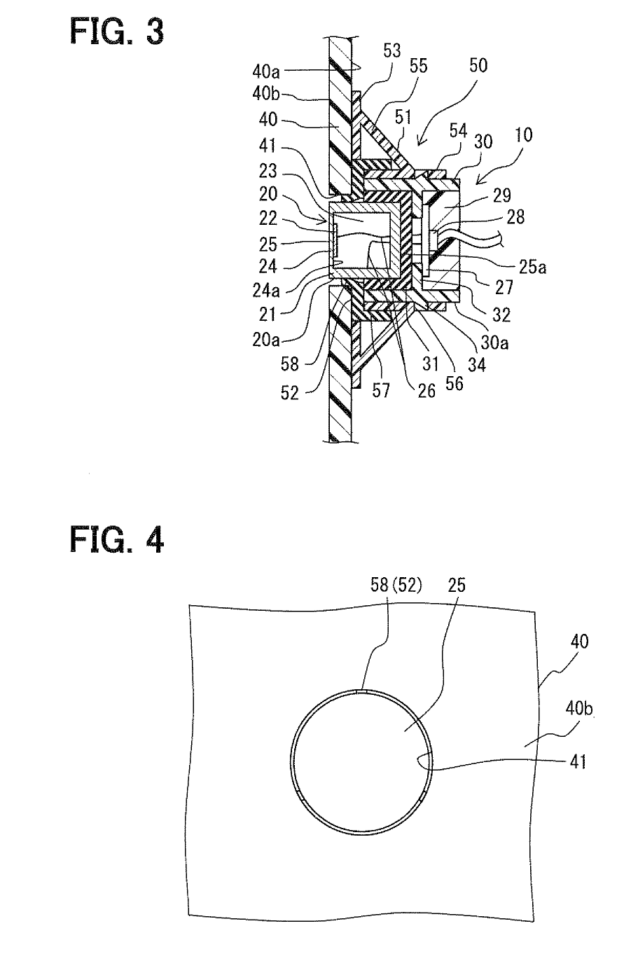

According to the above embodiments, the insertion portion 58 inserted into the through-hole 41 contacts the inner surface side corner part of the bumper 40, and thereby enabling determination of a position of the fixation member 50 relative to the bumper 40. However, as shown in FIG. 3 for instance, the insertion portion 58 may contact the wall surface defining the though-hole. This configuration also can determine the position of the fixation member 50 relative to the bumper 40. FIG. 3 is a cross sectional diagram illustrating a modification example corresponding to FIG. 1. According to an example illustrated in FIG. 3, the ditch part 57a is not disposed in the retainer fixation portion 57 of the positioning member 52, and the positioning member 52 made of silicon rubber is adhered to the retainer 51.

Further, according to the above embodiments, the insertion portion 58 having a ring shape contacts the inner surface side corner part of the bumper 40 in the entire circumference, and thereby, the position of the fixation member 50 relative to the bumper 40 in the perpendicular direction is determined. However, a shape of the insertion portion 58 for providing the positioning function is not limited to the ring-shape. Three or more insertion portions 58 may be spaced away from each other so as to surround a periphery of the ultrasonic transducer 20, and radial thicknesses of parts to be located in the through-hole 41 may be almost the same. According to an example illustrated in FIG. 4 for instance, three insertion portions 58 are disposed so that a distance between adjacent insertion portions 58 (an angle between a line interconnecting one of two adjacent insertion portions 58 and the center of the through-hole 41 and a line interconnecting the other of two adjacent insertion portions 58 and the center of the through-hole 41) is constant. Further, radial thicknesses of parts of the insertion portions 58 located inside the through-hole 41 are generally equal to each other. Although not shown in the drawings, the three insertion portions 58 extend from a through-hole side end part of the retainer fixation portion 57 having a ring shape. In the case of using the multiple insertion portions 58 spaced away from each other, a portion in which the insertion portions 58 exist has clearances between adjacent insertion portions 58 in a gap between the oscillation surface 25 and the bumper 40 in a laminating direction (in other words, the insertion portions 58 interrupt only parts of a ring-shaped gap that connects between the outer surface 40b of the bumper 40 and the inner surface 40a of the bumper 40). Thus, in terms of design, it may be preferable that the insertion portion 58 have a ring shape as illustrated in the above embodiments. FIG. 4 is a plan view illustrating a modification example of the positioning member corresponding to FIG. 2.

Further, according to the above embodiments, the inner periphery surface of the ring-shaped insertion portion 58 has the tapered part which is located in the predetermined range starting from the end distant from the outer surface 40b and which tapers toward the outer surface 40b while reducing a radial dimension. However, the part having a tapered shape is not limited to the above-described example, and may be an arbitrary part of the inner periphery surface of the ring-shaped insertion portion 58. For example, in the example illustrated in FIG. 3, the inner periphery surface of the ring-shaped insertion portion 58 has: a part which occupies a predetermined region starting from an end distant from the outer surface 40b and which is generally parallel to the side surface 20a of the ultrasonic transducer 20; and another part which occupies another predetermined region from the parallel part and which tapers while reducing a radial dimension.

Further, according to the above embodiments, the retainer 51 fixation portion and the insertion portion 58 of the positioning member 52 are spaced away. However, in a fixation method such as adhering, integral molding and the like, an end part of the insertion portion 58 may function as the retainer fixation portion to provide a structure where the insertion portion 58 and the retainer 51 is fixed. For example, there may be provided a structure where the retainer fixation portion 57 illustrated in FIG. 1 is replaced with the retainer 51.

Further, according to the above embodiments, in the insertion portion 58, the part contacting the side surface 20a of the ultrasonic transducer 20 is located closer to the outer surface 40b of the bumper 40 compared to the part connecting with the retainer fixation portion 57. Further, the opening area defined by the insertion portion 58 with the ring shape reduces as closer to the outer surface 40b of the bumper 40. However, in an alternative configuration, the part connecting with the retainer fixation portion 57 may be located closer to the outer surface 40b of the bumper 40 compared to the part contacting the side surface 20a of the ultrasonic transducer 20, and the opening area defined by the insertion portion 58 with the ring shape may reduce as closer to the inner surface 40a of the bumper 40.

Further, according to the above embodiments, the retainer 51 is adhesively fixed to the bumper 40. However, a fixing way is not limited to the above example. For example, it is also possible to appropriately employ a known fixing way such as fitting, screwing and the like.

Further, according to the above embodiments, the fixation member 50 is configured such that the positioning member 52 is fitted into and combined with the retainer 51 for fixing the ultrasonic sensor 10 to the bumper 40. However, a way of fixing the positioning member 52 to the retainer 51 is not limited to the above example. For example, it is possible to employ bonding, screwing, integral molding (e.g., molding with the use of two materials), clumping with another member, and the like.

Further, according to the above embodiments, a vehicle is illustrated as an example of a movable body. Alternatively, application to a movable body other than a vehicle is possible. Further, a vehicle bumper is illustrated as an example of a wall member. Alternatively, a wall member may be other than a vehicle bumper, such as a vehicle body (e.g., a thin plate made of metal), a resin molding (e.g., protection member disposed on a part of a bumper or a part of body) and the like.

Further, according to the above embodiments, an opening shape of the through-hole 41 and a shape of the oscillation surface (a shape defined by the side surface of the ultrasonic transducer 20) are mutually circular. However, these shapes are not limited to circular. Arbitrary shapes that are mutually the same (different in dimension) can be employed.

Further, according to the above embodiments, the retainer 51 is made of PBT. However, the material for the retainer 51 is not limited to the above example if the material allows the fixing of the ultrasonic sensor 10 to the bumper 40.

Further, according to the above embodiments, the positioning member 52 is made of silicon rubber. However, the material for the positioning member 52 is not limited to the above example if the material allows restriction of unwanted vibration transmission between the ultrasonic transducer 20 and the bumper 40.

Further, according to the above embodiments, the sensor fixation portion 54 has a cylindrical shape so as to surround an outer peripheral surface 30a of the case 30. Alternatively, as the shape the sensor fixation portion 54, it is also possible to appropriately employ the shape that allows the case 30 of the ultrasonic sensor 10 to be received and retained therein.

Further, according to the above embodiments, in the retainer fixation portion 57, the ditch part 57a is formed on a part that contacts the inner surface 40a of the bumper 40, and the ditch part 57a is fitted into the bumper 40 side end part of the sensor fixation portion 54 to thereby combine the retainer 51 and the positioning member 52. Alternatively, as shown in FIG. 3, the retainer fixation portion 57 may not have the ditch part 57a. This also enables combination of the retainer 51 and the positioning member 52.

Further, according to the above embodiments, the housing 21 of the ultrasonic transducer 20 has a tubular shape with a closed end. However, the shape of the housing 21 is not limited to the above example.

Further, according to the above embodiments, the housing 21 is made of aluminum. Alternatively, it is possible to employ a material with an electric conductivity accordingly.

Further, according to the above embodiments, the case 30 is made of PBT. Alternatively, it is possible to arbitrarily employ a material having an insulation characteristic.

Further, according to the above embodiments, the case 30 has a cylindrical shape. However, the shape of the case 30 is not limited to this example.

Further, according to the above embodiments, the vibration insulation member 31 is made of silicon rubber. Alternatively, as the material for the vibration insulation member 31, it is possible to employ a material that allows the restriction of unwanted vibration transmission between the ultrasonic transducer 20 and the case 30.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

What is claimed is:

1. An attachment structure comprising:
an ultrasonic sensor including: an ultrasonic transducer having an oscillation surface for ultrasonic wave transmission and reception; a case receiving the ultrasonic transducer with the oscillation surface being exposed from the case; and an vibration insulation member disposed between the case and the ultrasonic transducer to suppress unwanted vibration transmission between the ultrasonic transducer and the case;
a wall member equipped in a movable body, the wall member having a through-hole with an opening shape corresponding to a shape of the oscillation surface; and
a fixation member for attaching the ultrasonic sensor to the wall member so that the oscillation surface is exposed to an outer surface side through the through-hole,
wherein the case of the ultrasonic sensor receives the ultrasonic transducer from a rear surface opposite to the oscillation surface to a part of a portion of a side surface, the side surface being other than the rear surface and the oscillation surface, the portion of the side surface is located on an inner surface side, wherein the fixation member is disposed on an inner surface of the wall member and disposed around the through-hole, wherein the case is fixed by the fixation member so that the oscillation surface and the outer surface of the wall member are on a substantially same plane,
wherein the fixation member includes a positioning member, wherein the positioning member is inserted into the through-hole, and contacts one of a wall surface defining the through-hole and an inner surface side corner part connecting to the wall surface, and the part of the portion of the side surface of the ultrasonic transducer, the part of the portion of the side surface being exposed from the case, wherein the positioning member cause a center of the through-hole to match a center of the oscillation surface of the ultrasonic sensor, which is fixed to the fixation member,
wherein the positioning member is made of a material suppressible of vibration transmission between the ultrasonic transducer and the wall member.

2. The attachment structure according to claim 1, wherein:
the positioning member has a ring shape so as to surround a periphery of the ultrasonic transducer, and contacts an entire circumference of the part of the portion of the side surface of the wall member, the part being exposed from the case;

3. The attachment structure according to claim 1, wherein:
the positioning member has a facing surface that faces the side surface of the ultrasonic transducer, and at least a part of the facing surface tapers from an inner surface side of the wall member toward an outer surface side of the wall member while approaching the side surface of the ultrasonic transducer.

4. The attachment structure according to claim 1, wherein:
the positioning member is located closer the inner surface of the wall member than the outer surface of the wall member; and

5. The attachment structure according to claim 1, wherein:
the wall member is at least one of a bumper, a molding, a body of the vehicle.

6. An attachment structure for use in a vehicle, comprising:
an ultrasonic sensor including: an ultrasonic transducer having an oscillation surface for ultrasonic wave transmission and reception; a case receiving a part of the ultrasonic transducer with the oscillation surface being exposed from the case; and an vibration insulation member disposed between the case and the ultrasonic transducer to suppress vibration transmission between the case and the ultrasonic transducer; and
a fixation member for attaching the ultrasonic sensor to a wall member of the vehicle, the wall member having: an outer surface exposed to an outside of the vehicle; an inner surface opposite to the outer surface; and a through-hole penetrating between the outer and inner surfaces with an opening shape corresponding to a shape of the oscillation surface, wherein the fixation member is disposed on the inner surface of the wall member and disposed around the through-hole, wherein the fixation member attaches the ultrasonic sensor to the wall member so that the oscillation surface is exposed to the outside of the vehicle through the trough-hole,
wherein:
the ultrasonic sensor further has a rear surface opposite to the oscillation surface, and a side surface located between the oscillation surface and the rear surface;
the case receives the part of the ultrasonic transducer from the rear surface of the ultrasonic transducer so that a part of the side surface of the ultrasonic transducer is exposed from the case;
the fixation member includes:
a retainer that fixes the case so that the oscillation surface and the outer surface of the wall member are on a substantially same plane, and so that the exposed part of the side surface of the ultrasonic transducer is located in the through-hole and located closer the outer surface of the wall member than the inner surface; and
a positioning member that is inserted into the through-hole, contacts the exposed part of the side surface of the ultrasonic transducer, further contacts at least of an inner wall surface side corner part and a wall surface defining the through-hole of the wall member, and positions the ultrasonic transducer at a place where a center of the oscillation surface substantially matches a center of through-hole, the inner surface side corner part which connects the wall surface of the through-hole and the inner surface of the wall member; and
the positing member is made of a material suppressible of vibration transmission between the ultrasonic transducer and the wall member.

7. The attachment structure according to claim 6, wherein:
the positioning member has a ring shape surrounding a periphery of the ultrasonic transducer and contacts an entire circumference of the exposed part of the side surface of the wall member;
the positioning member has a facing surface that faces the side surface of the ultrasonic transducer, and at least a part of the facing surface tapers from an inner surface side of the wall member toward an outer surface side of the wall member while approaching the side surface of the ultrasonic transducer;
the positioning member is located closer the inner surface of the wall member than the outer surface of the wall member; and
the wall member is at least one of a bumper, a molding, a body of the vehicle.

8. An attachment structure for use in attaching an ultrasonic sensor to a wall member of a vehicle,
the ultrasonic sensor including: an ultrasonic transducer having an oscillation surface for ultrasonic wave transmission and reception, and a rear surface opposite to the oscillation surface; a case receiving a part of the ultrasonic transducer from the rear surface of the ultrasonic transducer so that a part of a side surface located between the oscillation surface and the rear surface is exposed from the case; and an vibration insulation member disposed between the case and the ultrasonic transducer to suppress vibration transmission between the case and the ultrasonic transducer,
the wall member having: an outer surface exposed to an outside of the vehicle; an inner surface opposite to the outer surface; and a through-hole penetrating between the outer and inner surfaces with an opening shape corresponding to the oscillation surface,
the attachment structure comprising:
a fixation member that is disposed on the inner surface of the wall member and disposed around the through-hole, and that attaches the ultrasonic sensor to the wall member so that the oscillation surface is exposed to the outside of the vehicle through the trough-hole,
the fixation member including:
a retainer that fixes the case so that the oscillation surface and the outer surface of the wall member are on a substantially same plane, and so that the exposed part of the side surface of the ultrasonic transducer is located in the through-hole and located closer the outer surface of the wall member than the inner surface; and
a positioning member that is inserted into the through-hole, contacts the exposed part of the side surface of the ultrasonic transducer, further contacts at least one of an inner wall surface side corner part and a wall surface defining the through-hole of the wall member, and positions the ultrasonic transducer at a place where a center of the oscillation surface substantially matches a center of through-hole, the inner surface side corner part which connects the wall surface of the through-hole and the inner surface of the wall member,
wherein the positing member is made of a material suppressible of vibration transmission between the ultrasonic transducer and the wall member.

9. The attachment structure according to claim 8, wherein:
the positioning member has a ring shape to surround a periphery of the ultrasonic transducer, and contacts an entire circumference of the exposed part of the side surface of the wall member;
the positioning member has a facing surface that faces the side surface of the ultrasonic transducer, and at least a part of the facing surface tapers from an inner surface side of the wall member toward an outer surface side of the wall member while approaching the side surface of the ultrasonic transducer;
the positioning member is located closer the inner surface of the wall member than the outer surface of the wall member; and
the wall member is at least one of a bumper, a molding, a body of the vehicle.
